(19) United States
(12) Patent Application Publication
(10) Pub. No.: US 2006/0267723 A1
(43) Pub. Date: Nov. 30, 2006

(54) Chip-type resettable over-current protection device structure

(76) Inventors: Kang-Neng Hsu, Miaoli County (TW); Ting Hsu, Miaoli County (TW)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/440,158

(22) Filed: May 25, 2006

(30) Foreign Application Priority Data
May 26, 2005 (TW) 094208663

(51) Int. Cl. H01C 7/10; H01C 7/13

(52) U.S. Cl. 338/22 R

(57) ABSTRACT

The present invention relates to a chip-type resettable over-current protection device structure using a substrate composed of a Polymeric Positive Temperature Coefficient (PPTC) material and covered by an upper electrode and a lower electrode, mainly characterized in that the overall area of the Polymeric Positive Temperature Coefficient (PPTC) material may be used to fabricate a main electrode structure of the device, so as to produce an over-current protection device with a higher rated current. Furthermore, the present invention does not need a through-hole or etching process which is generally needed for fabricating the over-current protection device.

### BACKGROUND OF THE INVENTION

The invention relates to an electrode structure of a chip-type resettable over-current protection device, and particularly to a main electrode structure of the device fabricated on the Polymeric Positive Temperature Coefficient (PPTC) material with the overall area thereof. Thereby, a higher rated current specification would be made with the same over-current protection element size in the present invention than in the prior art.

### DESCRIPTION OF THE PRIOR ART

The chip-type resettable over-current protection device has been found in a wide range of applications in the circuits of various electronic system products. The main structure of the device is at least one Polymeric Positive Temperature Coefficient (PPTC) material layer. The PPTC material layer is characterized in that when the temperature is increased to a specific temperature, its resistance will jump up dramatically to block the current, thereby a protection circuit or over-current protection element can be made. In addition to the PPTC material layer, the main structure of the resettable over-current protection device further includes a main electrode structure formed by sheet-like laminates attached to the upper and lower surfaces of the PPTC material layer.

In the fabrication process of the general resettable over-current protection device, an end electrode isolating region will be formed by etching the main electrode structure respectively at the upper and lower ends of the main electrode structure of the resettable over-current protection element. In the isolating regions, the PPTC material layer will be exposed since the electrodes of the isolating regions are removed. Moreover, the dimensions required by the end electrodes are reserved in the fabrication process of the general resettable over-current protection device.

Therefore, for an over-current protection element, the area that the PPTC material layer actually overlaps with the upper and lower electrodes is obtained after deducting the dimension of the isolating regions on the upper and lower electrode structures and that of the end electrodes. Thus, if an over-current protection element with a higher rated current specification is desired, a plurality of overlapped main electrode structures are generally used.

If an over-current protection element with a higher rated current specification can be made with the same number of structural layers, the material of the chip-type resettable over-current protection element will be reduced efficiently, and the problems of process resource consumption and waste treatment will also be reduced.

American Tyco Electronics Corp.'s U.S. Pat. No. 6,292,088 is a chip-type resettable over-current protection device structure and the fabrication process thereof as shown in FIGS. 1A-1L. As shown in FIGS. 1A and 1B, first the sheet-like upper and lower electrodes (11a) and (11b) are adhered on a PPTC substrate (10). FIG. 1D shows the sectional view of a sandwiched structure of an over-current protection device taken along the section line A-A of FIG. 1C. Through-holes (12) for connecting the upper and lower electrodes are made on designed positions of FIG. 1E. FIG. 1F is a sectional view of an over-current protection device taken along the section line A-A of FIG. 1E. As shown in FIGS. 1G and 1H, electrode-connecting conductors (13) are made via the through-holes (12). As shown in FIGS. 1I and 1J, electrode isolating regions (14) required by both end electrodes (20, 21) of the over-current protection element are made on the upper electrode (11a) and lower electrode (11b) of the over-current protection device. After the above steps, the fabricated main electrode structure is cut into individual over-current protection elements along cut lines (15) designed in FIG. 1I. As shown in FIG. 1L, two separate end electrodes (20, 21) as well as the electrode structure for upper-and-lower electrode connection of the chip-type over-current protection device are formed.

Such a conventional structure and fabrication is primarily to connect the electrode conductors through the through-holes after finishing the main structure of the upper electrode conductor, the PPTC material layer and the lower electrode conductor, and then to create a end electrode isolating region on the upper electrode and the lower electrode respectively. Furthermore, it also can be seen in FIGS. 1K and 1L that a predetermined size is reserved for the end electrodes during the fabrication.

It is understood in the prior art structure and fabrication process that:

1. In order to avoid a short circuit between the end electrode and the inner main electrode in the over-current protection element, as shown in FIGS. 1I and 1J, end electrodes (20, 21) and isolating regions (14) of the inner main electrode must be provided respectively in the upper and lower electrodes on the front face of the over-current protection element; and at the same time a certain size must be reserved for the end electrodes for assembling the over-current protection element.

2. As required by the electrode design and fabrication, a valid overlap area with the upper and lower electrodes on the PPTC substrate of the front and back faces of the over-current protection element is only the central part; and if the same single-layer PPTC substrate is used as a main body, but the PPTC material is overlapped with the overall area of the upper and lower electrodes, the resulting resistance of the over-current protection element will be reduced effectively. In other words, an over-current protection device structure with a higher rated current specification can be made.

3. When creating the isolating regions (14) on the upper and lower electrodes of the over-current protection element, the electrode conductors adhered to the PPTC substrate have to be removed, which is energy consuming and also leads to environmental problems.

In view of the problems in the above chip-type resettable over-current protection device structure and fabrication process, the present invention is proposed for the purpose of reducing the material wasted in fabricating the chip-type resettable over-current protection element, and reducing the process resource consumption and waste treatment, while fabricating an over-current protection element with a higher rated current specification with material of the same size as previous.

### SUMMARY OF THE INVENTION

A first object of the present invention is to provide a chip-type resettable over-current protection device structure. The overall area of an upper electrode and a lower electrode of a main electrode structure overlaps with a PPTC material, and an over-current protection element with a higher rated current specification can be fabricated with the same material and same number of PPTC material layers.

A second object of the present invention is to provide a fabrication process of a chip-type resettable over-current protection device, wherein the material waste due to the above described process can be reduced, and the problem of waste treatment as well as the processes can also be lessened without the need for the through-holes and etching processes required by the conventional art.

To achieve the above objects, according to a first aspect of the resettable over-current protection device of the present invention, the resettable over-current protection device comprises: a substrate, having an upper surface and a lower surface; an upper electrode and a lower electrode, covering the upper surface and the lower surface of the substrate respectively; an upper insulating layer and a lower insulating layer, covering the upper electrode and the lower electrode respectively; a left end face insulating layer and a right end face insulating layer, being coated onto a left end face and a right end face of the substrate respectively; and a left end electrode conductor and a right end electrode conductor, formed on the left end face insulating layer and the right end face insulating layer respectively; wherein the overall area of the upper and lower surfaces of the substrate fully overlaps with the upper electrode and the lower electrode.

According to a second aspect of the resettable over-current protection device of the present invention, the resettable over-current protection device comprises: a plurality of substrates, each of which is laminated by at least two sheets of electrode conductors to form a multilayer over-current protection element, wherein an electrode disposed between the plurality of substrates is an intermediate electrode; an upper insulating layer, covering an upper surface of the multilayer over-current protection element; a lower insulating layer, covering a lower surface of the multilayer over-current protection element; wherein the multilayer over-current protection element has a left end face and a right end face having a left end face insulating layer and a right end face insulating layer respectively, wherein the right end face insulating layer of the multilayer over-current protection element does not cover the intermediate electrode of the multilayer over-current protection element, and the upper electrode and the lower electrode of the multilayer over-current protection element have an upper electrode joining region and a lower electrode joining region respectively; and wherein the overall area of the substrate in the multilayer over-current protection element fully overlaps with the upper electrode, the lower electrode and the intermediate electrode.

The detailed structure, other objects and efficacies of the present invention will be understood fully with reference to the following descriptions.

### BRIEF DESCRIPTION OF THE DRAWINGS

FIGS. 1A-1L are schematic views of a conventional chip-type resettable over-current protection device structure and the fabrication process thereof;

FIGS. 2A-2L show the structure of a chip-type resettable over-current protection device in accordance with a first embodiment of the present invention;

FIGS. 3A-3L show the structure of a chip-type resettable over-current protection device in accordance with a second embodiment of the present invention.

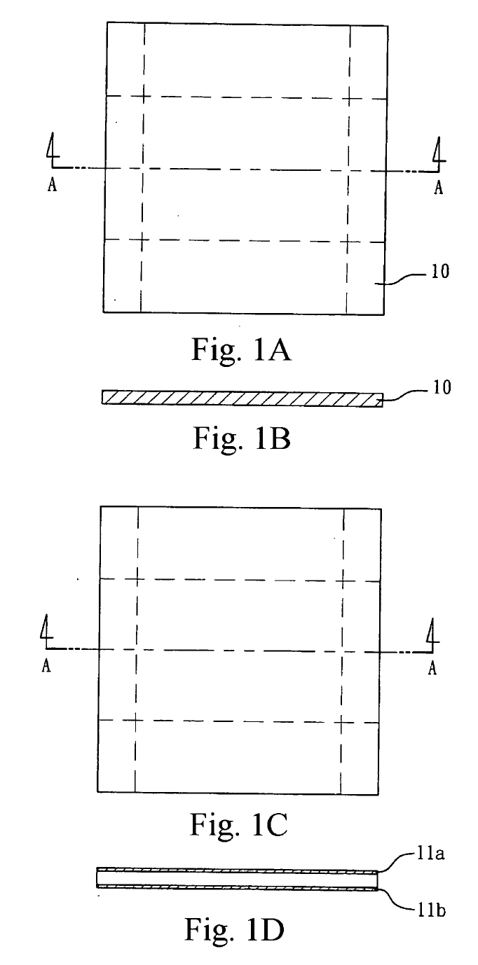

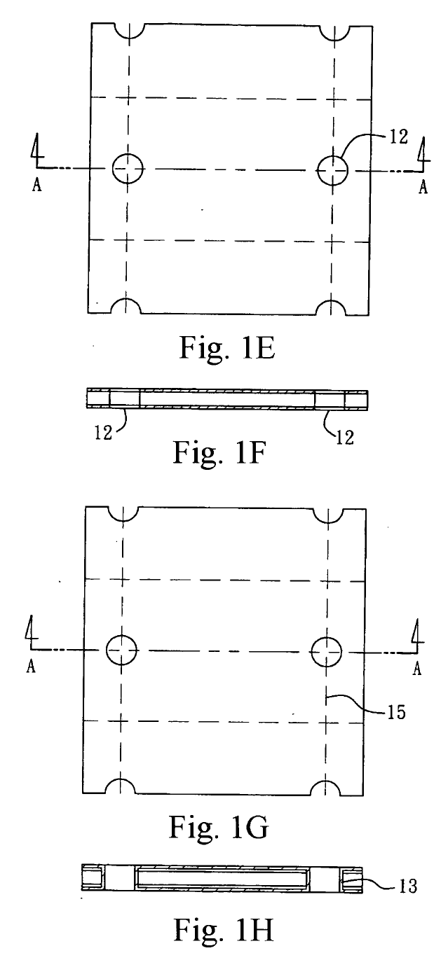

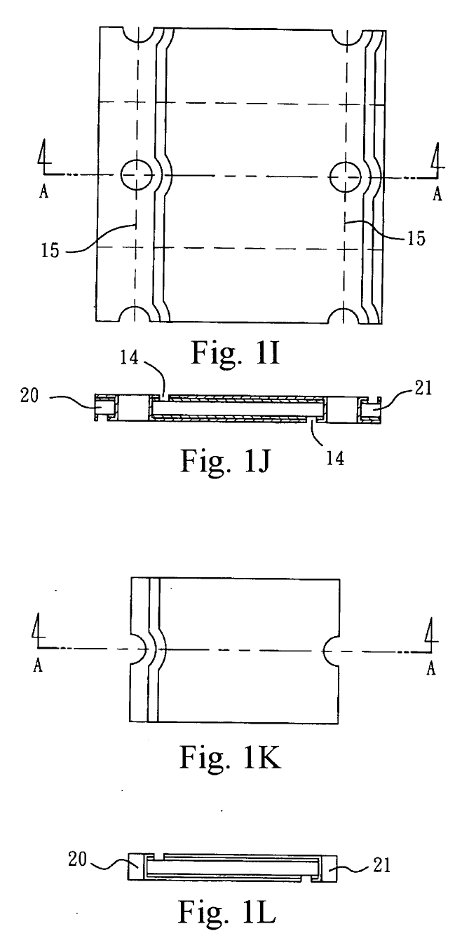

### DETAILED DESCRIPTION OF THE INVENTION

Aiming at the problems in the conventional fabrication of the chip-type resettable over-current protection device, and based on the market demands for the existing chip-type resettable over-current protection device, the solution of the present invention is proposed.

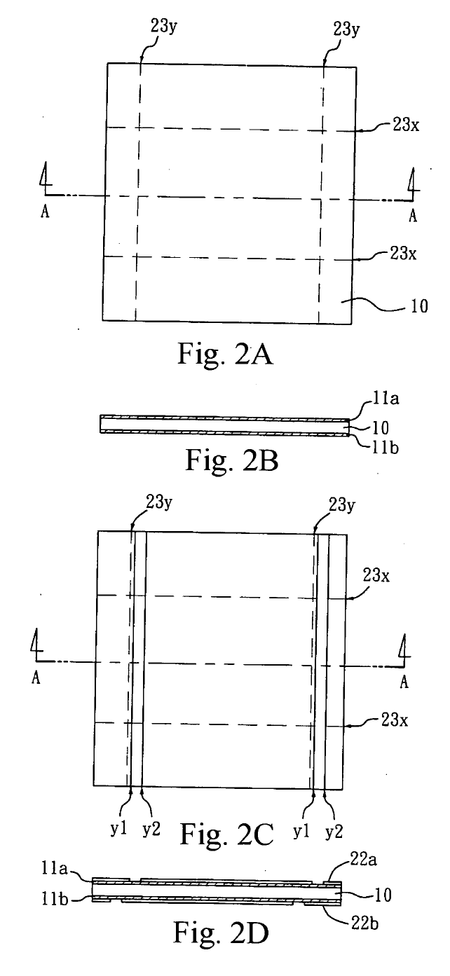

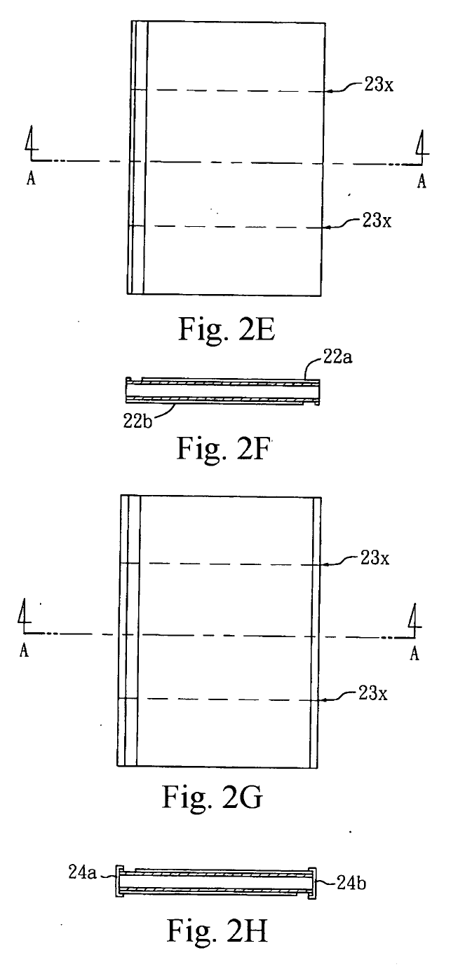

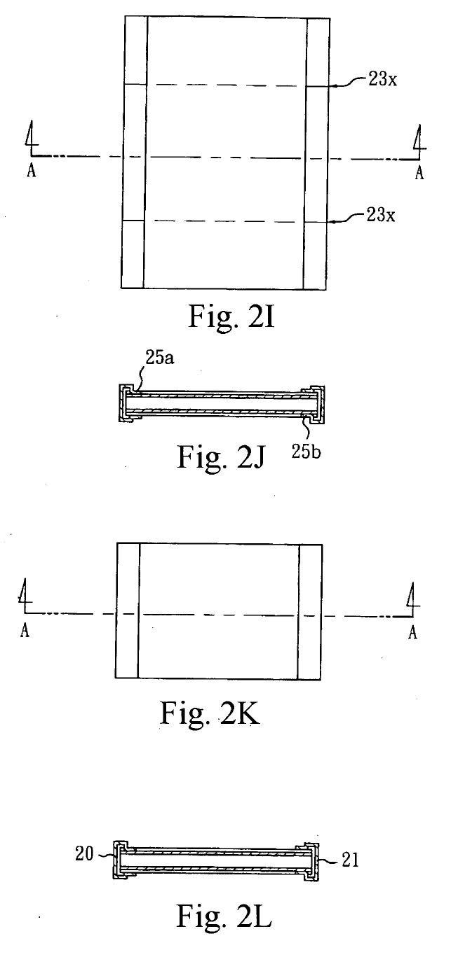

FIGS. 2A-2L show the structure of a first embodiment of the chip-type resettable over-current protection device in the present invention. First, a substrate (10) as shown in FIG. 2 is prepared, and the sheet-like upper electrode (11a) and lower electrode (11b) are adhered onto the substrate (10), to form a main electrode structure as shown in FIG. 2B. Then, an upper insulating layer (22a) of the upper electrode (11a) and a lower insulating layer (22b) of the lower electrode (11b) are made directly on the designed positions (y1, y2) as shown in FIG. 2C, to form the structure as shown in FIG. 2D. Then the substrate of the electrode structure as shown in FIG. 2D is cut along the cut line (23y) in FIG. 2C, into striped structures shown in FIG. 2F taken along the section line A-A in FIG. 2E. Again as shown in FIG. 2G, the coating of the left end face insulating layer (24a) and the right end face insulating layer (24b) is carried out on the edges of the cut striped structures, to form a laminate structure as shown in FIG. 2H. Then, as shown in FIGS. 2I and 2J, a joining region (25a, 25b) to be jointed by the end electrodes is exposed on the upper electrode (11a) and the lower electrode (11b) respectively, with the remaining part completely isolated. After that, end electrode fixed-depth coating (or the end electrode silver epoxy fixed-depth adhesion) is carried out, for example, by a end electrode sputtering deposition process, so as to achieve a left end electrode conductor (20) and a right end electrode conductor (21), as shown in FIGS. 2K and 2L. Finally, the striped substrates are cut into particulates along the cut line (23x), and thereby achieving the resettable over-current protection device structure.

The solder interface layer required by the end electrodes of the chip-type over-current protection element may be formed by rack plating the striped substrates of the left end electrode conductor (20) and the right end electrode conductor (21) made in FIGS. 2I and 2J, or by barrel plating after the substrates are cut into particulates in FIGS. 2K and 2L.

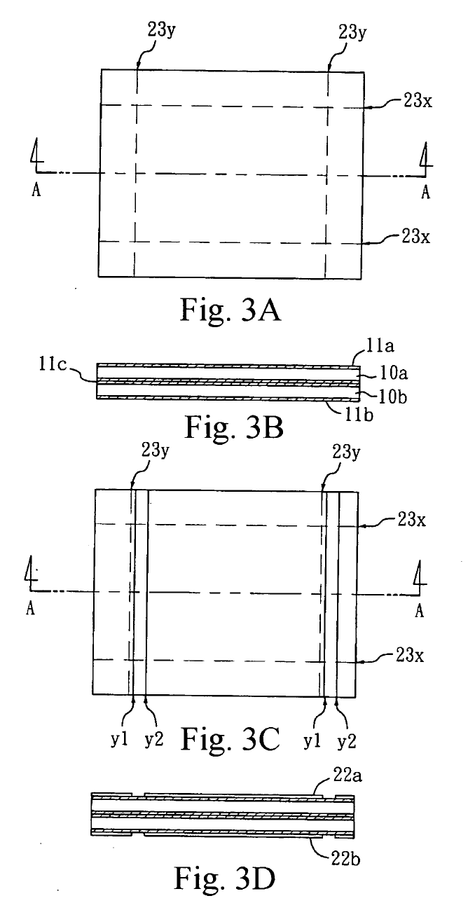

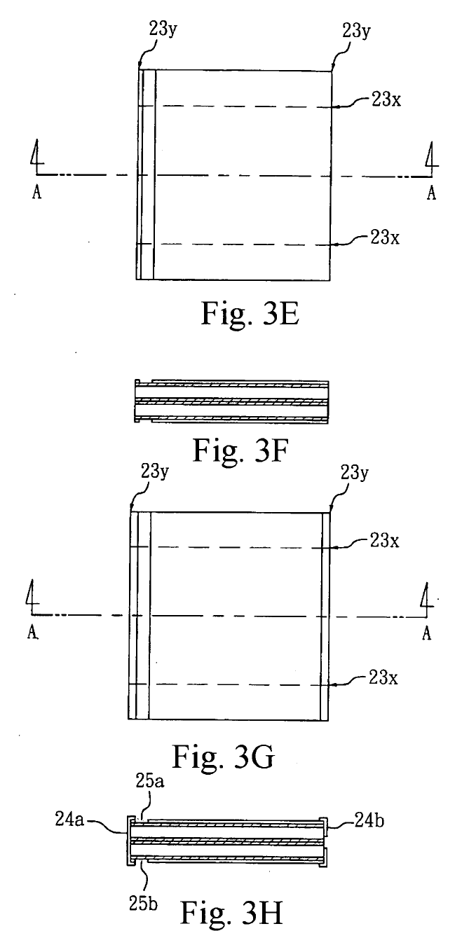

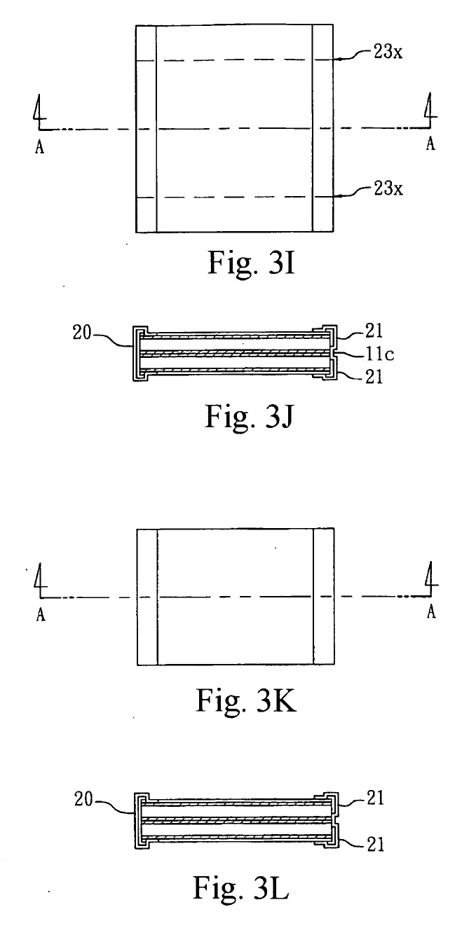

FIGS. 3A-3L show the structure of a second embodiment of the chip-type over-current protection device of the present invention. First, two substrates (10a and 10b) as shown in FIGS. 3A and 3B are prepared, and the sheet-like electrode conductors, i.e., the upper electrode 11a), the lower electrode 11b) and the intermediate electrode (11c), are laminated directly with the two substrates (10a, 10b), thus forming the multilayer structure as shown in FIG. 3B, wherein the intermediate electrode (11c) between the two substrates may also be replaced by an adhesive sheet sandwiched between the two sheet-like electrode conductors. Then, at designed positions (y1, y2) as shown in FIG. 3C, an upper insulating layer (22a) and a lower insulating layer (22b) are formed respectively on the upper electrode 11a) and the lower electrode 11b) of the multilayer structure, thus producing an electrode structure as shown in FIG. 3D. Then, the multilayer structure as shown in FIG. 3D is cut into strips as shown in FIG. 3F along the cut line (23y) in FIG. 3E. Coating of a left end face insulating layer (24a) and right end face insulating layer (24b) is carried out on two edges of the striped structures along the cut line (23y) shown in FIG. 3G, thus producing an electrode structure as shown in FIG. 3H, wherein the left end face insulating layer (24a) exposes the regions (25a, 25b) to be jointed by the end electrodes respectively on the upper electrode 11a) and the lower electrode 11b) of left end electrode of the over-current protection element, while the remaining end face insulating layer (24b) only exposes the end face of the intermediate electrode (11c), with the remaining part completely isolated.

After that, the end electrode fixed-depth coating or the end electrode adhesive fixed-depth adhesion is carried out, for example, by a end electrode sputtering deposition process, to achieve the left end electrode conductor (20) and the right end electrode conductor (21) as shown in FIGS. 3I and 3J. Finally, the striped substrates are cut along the designed cut line (23x) into finished over-current protection device structures as shown in FIGS. 3K and 3L.

The solder interface layer required by the chip-type over-current protection element end electrode can be formed by rack plating the striped substrates of the left end electrode conductor (20) and the right end electrode conductor (21) made as shown in FIGS. 3I and 3J, or by barrel plating after the substrates are cut into particulates as shown in FIGS. 3K and 3L. As shown in the embodiment of the chip-type resettable over-current protection device structure of the present invention, the overall area of the sheet-like electrode conductors laminated on the Polymeric Positive Temperature Coefficient (PPTC) material is made into the main electrode structure of the over-current protection device.

The efficacies of the present invention are as follows:

1. The sheet-like electrode conductors laminated on the PPTC material can reduce the problems of resource consumption and waste treatment without the need for an etching process to form the end electrode isolating regions.

2. The sheet-like intermediate electrode conductors are of an overall overlap design on the PPTC material, and an over-current protection element with a higher rated current specification can be achieved with the same material and same number of PPTC material layers.

The chip-type resettable over-current protection device structure of the present invention has the efficacies described above, and there is no similar chip-type resettable over-current protection device structure in conventional chip-type resettable over-current protection devices. It is clear for those skilled in the art that any modification to the present invention without departing from the spirit of the present invention falls into the scope claimed by the present invention.

We claim:

1. A chip-type resettable over-current protection device, comprising:
a substrate, having an upper surface and a lower surface;
an upper electrode and a lower electrode, covering the upper surface and the lower surface, respectively;
an upper insulating layer and a lower insulating layer, covering the upper electrode and the lower electrode, respectively;
a left end face insulating layer and a right end face insulating layer, coated on a left end face and a right end face of the substrate; and
a left end electrode conductor and a right end electrode conductor, formed on the left end face insulating layer and the right end face insulating layer, respectively;
wherein the overall area of the upper surface and the lower surface of the substrate fully overlaps with the upper electrode and the lower electrode.

2. The device as claimed in claim 1, wherein the substrate is composed of a Polymeric Positive Temperature Coefficient material.

3. The device as claimed in claim 1, wherein the left end electrode conductor and the right end electrode conductor of the substrate are formed with end electrode fixed-depth coating by an end electrode sputtering deposition process.

4. The device as claimed in claim 1, wherein the left end electrode conductor and the right end electrode conductor of the substrate are formed with end electrode fixed-depth coating by an end electrode silver epoxy adhesion process.

5. A chip-type resettable over-current protection device, comprising:
a plurality of substrates, each of which is laminated by at least two sheets of electrode conductors, to form a multilayer over-current protection element, wherein an electrode disposed between the plurality of substrates is an intermediate electrode;
an upper insulating layer, covering an upper surface of the multilayet over-current protection element; and
a lower insulating layer, covering a lower surface of the multilayer over-current protection element;
wherein the multilayer over-current protection element has a left end face and a right end face, the left end face and the right end face being provided with a left end face insulating layer and a right end face insulating layer respectively, wherein the right end face insulating layer of the multilayer over-current protection element does not cover the intermediate electrode of the multilayer over-current protection element, and
the upper electrode and the lower electrode of the multilayer over-current protection element have an upper electrode joining region and a lower electrode joining region respectively; and
wherein the overall area of the substrate in the multilayer over-current protection element fully overlaps with the upper electrode, the lower electrode and the intermediate electrode.

6. The device as claimed in claim 5, wherein the substrate is made of a Polymeric Positive Temperature Coefficient material.

7. The device as claimed in claim 5, wherein the left end electrode and the right end electrode of the multilayer over-current protection element are formed with an end electrode fixed depth coating by an end electrode sputtering deposition process.

8. The device as claimed in claim 5, wherein the left end electrode and the right end electrode of the multilayer over-current protection element are formed with an end electrode fixed-depth coating by an end electrode silver epoxy adhesion process.
